(19) United States
(12) Patent Application Publication
(10) Pub. No.: US 2003/0212485 A1
(43) Pub. Date: Nov. 13, 2003

(54) Navigation system interface for vehicle

(76) Inventor: Mark Michmerhuizen, Holland, MI (US)

Correspondence Address: FOLEY & LARDNER, 777 EAST WISCONSIN AVENUE, SUITE 3800, MILWAUKEE, WI, 53202-5308, US

(21) Appl. No.: 10/141,811

(22) Filed: May 9, 2002

(51) Int. Cl. G01C 21/00

(52) U.S. Cl. 701/200; 701/1

(57) ABSTRACT

A system for displaying information to a user in a vehicle having a vehicle interior element comprises an interface coupled to the vehicle interior element configured to establish a communication link with a portable computing device, a display unit, and a processing circuit. The processing circuit is configured to receive the information from the portable computing device, to process the stored information and to provide the information for display on the display unit.

### FIELD OF INVENTION

This invention relates generally to the field of a system, method and apparatus for providing information to a mobile unit, and more particularly, a system, method and apparatus for displaying information or data in a vehicle.

### BACKGROUND OF THE INVENTION

Systems have been developed which provide geographical or position-dependent information to a mobile user. Such systems are generally installed in an automobile or other vehicle. These systems include an on-board geographic information database or navigation database which may be accessed to determine geographic information, such as locations of points of interest, directions to points of interest, and directions between a specified origin and a destination. An on-board computer calculates route guidance information using data from the database in response to user inputs.

Such systems are known as autonomous route guidance systems since they are independent and self-contained. The systems generally include a geographic database, positioning or location-determining sensors, and a computer including a keyboard and display. The geographic database includes representations of a region or metropolitan area and may include, for example, street names, navigation attributes, such as turn restrictions and one-way streets, street addresses, and points of interest, such as airports, restaurants and museums. The positioning sensors may determine geographic position from RF (radio frequency) triangulation or in response to signals from, for example GPS (Global Positioning System) satellites, LORAN C, or other similar positioning systems, and from motion and direction detectors. The computer calculates route guidance information in response to inputs from the other system components as well as from operator input. The route guidance information is provided to the user in the form of navigational text or map graphics.

Autonomous route guidance systems have many drawbacks, however, which have prevented their wide-spread use. Because the system is autonomous and has an on-board database, the system must include large storage capabilities for storing all of the data which form the database. Technologies such as CD-ROM or DVD have allowed storage of a large database but are limited in memory size.

Another problem with autonomous route guidance systems is maintenance and currency of the database. As new streets are built, or as old streets are reconfigured, as businesses and other points of interest open and close, the database on CD-ROM or other media becomes out of date. In addition, when a database is compiled, it may include errors which are then replicated in the many copies provided to users. These errors may require correction in the multiple user copies. Moreover, incorrect or outdated information in the database can lead to errors when calculating routes. When an out-of-date database does not include the information that a particular roadway is closed, the system may be unable to calculate an alternate route.

Autonomous route guidance system providers may improve the accuracy of the system by providing occasional database updates to users. However, distribution of the database, in a medium such as CD-ROM or floppy disk, to remotely located mobile users is costly.

Other aspects of such prior art autonomous route guidance systems add to their cost and inconvenience. Because the systems are autonomous, they must include all components, including a computer, a database and a position sensor. Using present technology, such a system is too heavy and too large to be readily transported by an individual. In addition, the complete system has power requirements which make battery operation impractical. As a result, autonomous route guidance systems have been limited to installation in automobiles or other vehicles which can accommodate the size and power requirements of such a system. The current best price for a complete autonomous route guidance system is substantial. Some systems operate on personal digital assistants (PDAs), but these systems are inconvenient due to the need for cable connections and costly due to the need for a vehicle position sensor and a database on the vehicle.

Another type of route guidance system has been tested in Europe using beacons to provide a guidance signal to on-board equipment. The system directs the user to travel from beacon to beacon, creating a stepwise path between an origin and a destination because of the fixed locations of the beacons. The navigational information thus provides a generally inefficient routing path from origin to destination. In addition, such a system does not provide the capability to query a database for information about nearby points of interest and other geographical information.

Therefore, there is a need for displaying directional information to a user in a moving device without having costly databases. There is a further need for a routing and information system which can be implemented on lightweight, portable devices for easy, convenient transportation and use. There is a further need for a routing and information system which is independent of any particular hardware configuration and which may receive data or information from any suitably equipped data processing apparatus, such as a desktop personal computer, a laptop computer, a personal digital assistant (PDA), or a pager. There is a further need for a routing and information system which provides communication between mobile units and a base unit over any available channel, including hardwire, wireless, electronic, and optical channels.

### SUMMARY

One embodiment of the present invention is a system for displaying information to a user in a vehicle having a vehicle interior element. The system comprises an interface coupled to the vehicle interior element configured to establish a communication link with a portable computing device, a display unit, and a processing circuit configured to receive the information from the portable computing device, to process the stored information and to provide the information for display on the display unit.

Another embodiment of the present invention is a method for displaying navigation information to a user in a vehicle. The method comprises the steps of receiving the navigation information from a portable computing device via a communication link and displaying the navigation information on a display unit coupled to a vehicle interior element, wherein the current location of the vehicle is not displayed on the display unit.

Yet another embodiment of the present invention is a method for providing navigation data to a vehicle occupant in a vehicle. The method comprises the steps of receiving the navigation data from a portable computing device at a fixed computing device coupled to a vehicle interior element and providing the navigation data to the vehicle occupant via an output device.

Another embodiment of the present invention is an apparatus for displaying navigation data to a vehicle occupant in a vehicle. The apparatus comprises means for receiving the navigation data from a portable computing device at a fixed computing device coupled to a vehicle interior element and means for providing the navigation data to the vehicle occupant via an output device.

### BRIEF DESCRIPTION OF THE DRAWINGS

The features of the invention which are believed to be novel are set forth with particularity in the claims. The invention, together with further objects and advantages thereof, may best be understood by making reference to the following description taken in conjunction with the accompanying drawings, in the several figures of which like reference numerals identify identical elements, and wherein:

FIG. 1 is a diagram illustrating a vehicle having a system for displaying information to a user, according to an exemplary embodiment;

FIG. 2 is a functional block diagram illustrating details of the system shown in FIG. 1, according to an exemplary embodiment;

FIG. 3 is a functional block diagram illustrating another embodiment of the present invention, according to an exemplary embodiment;

FIG. 4 is a block diagram illustrating the details of a desktop computer mobile unit suitable for use with the system as shown in FIG. 1 or 2, according to an exemplary embodiment;

FIG. 5 is a block diagram illustrating the details of a laptop computer mobile unit suitable for use with the system as shown in FIG. 1 or 2, according to an exemplary embodiment;

FIG. 6 is a block diagram illustrating the details of a pager mobile unit suitable for use with the system as shown in FIG. 1 or 2, according to an exemplary embodiment;

FIG. 7 is a flow diagram illustrating a method according to an exemplary embodiment of the present invention; and

FIG. 8 is a flow diagram illustrating another method according to an exemplary embodiment of the present invention.

### DETAILED DESCRIPTION OF EXEMPLARY EMBODIMENTS

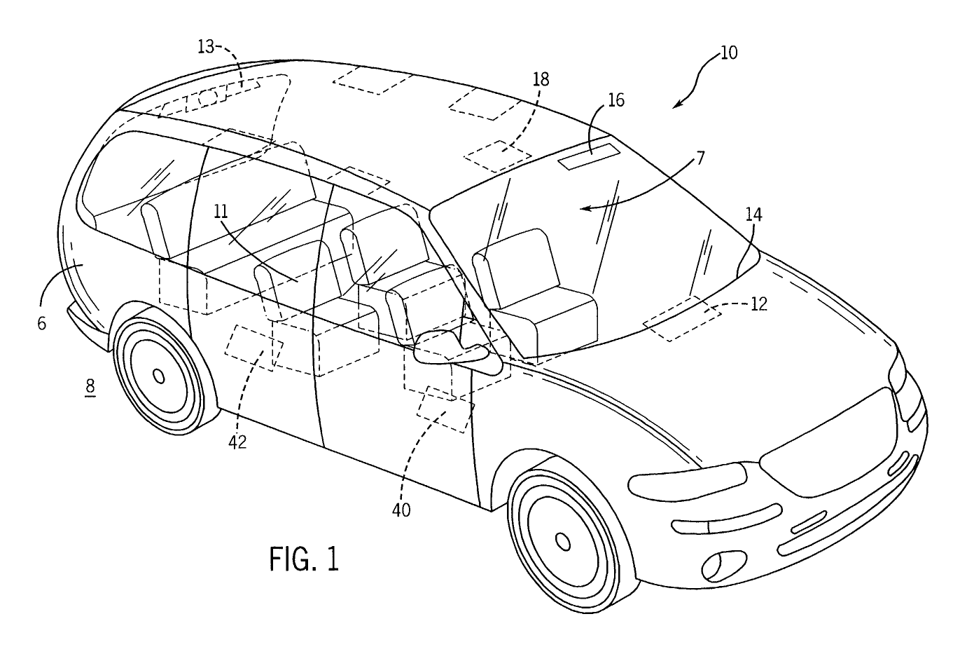

FIG. 1 discloses a vehicle 10 having a system 12 for displaying information to a user, according to an exemplary embodiment. FIG. 1 illustrates system 12, or one or more components of system 12, coupled to a vehicle interior element of vehicle 10, such as, an instrument panel 14, a visor 16, an overhead compartment 18, or another vehicle interior element, such as a steering wheel or a windshield. Vehicle 10 can be any type of automotive vehicle, construction vehicle, military vehicle, etc. In this exemplary embodiment, vehicle 10 is a minivan.

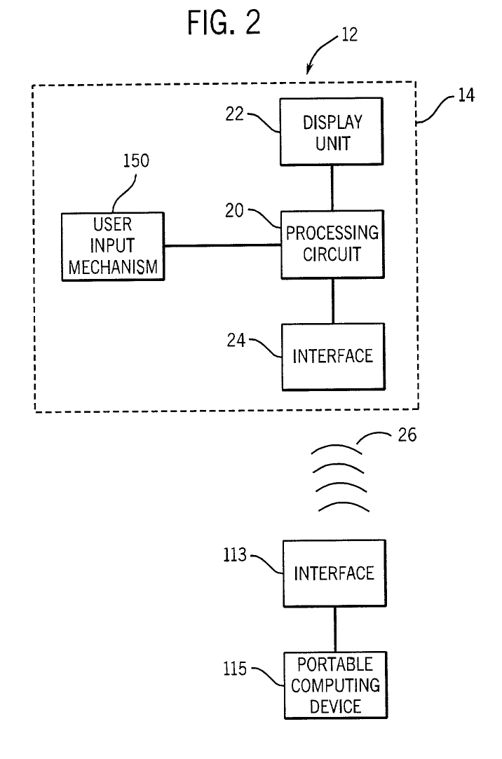

Referring now to FIG. 2, system 12 is illustrated in block diagram form along with a portable computing device 115. System 12 includes a processing circuit 20, a display unit 22, and an interface 24. In this embodiment, processing circuit 20, display unit 22, and interface 24 are coupled to a vehicle interior element, such as, instrumental panel 14. In alternative embodiments, one or more of processing circuit 20, display unit 22, and interface 24 may be coupled to different vehicle interior elements within the interior of vehicle 10.

Processing circuit 20 includes analog and/or digital circuitry, and may include a microprocessor, micro controller, application-specific integrated circuit (ASIC), or other control circuitry. In this embodiment, processing circuit 20 is configured to receive data or information from portable computing device 115 via an interface 24 and to provide the data for display on display unit 22. Processing circuit 20 is configured to received wired or wireless data via interface 24 in any of a variety of data transmission formats, such as a Bluetooth™ communications protocol, an IEEE 802.11b communications protocol, an RS-232 or RS-485 communications protocol, or other wired or wireless communications protocols or data formats. Processing circuit 20 is configured to receive data and to provide the data on display unit 22.

Display unit 22 is a liquid crystal display (LCD), vacuum fluorescent display (VFD), light emitting diode (LED) display, a heads-up display (HUD) such as a display projected onto a windshield, or a display having another display technology. Display unit 22 is driven by processing circuit 20 to display text, graphics, or other data or information in a manner suitable for use by a vehicle occupant. According to one example, navigation data in the form of a digital map can be displayed, as will be described in further detail hereinbelow.

System 12 can further include a user input mechanism 150, which can be a button, switch, dial, touch sensor within display unit 22, voice recognition receiver, or other user input mechanism. In this exemplary embodiment, user input mechanism 150 includes a plurality of buttons coupled to the vehicle interior, and preferably to the instrument panel. Processing circuit 20 is configured to control the display of data on display unit 120 in response to inputs from user input mechanism 150. Such control can include turning display unit 22 on or off, selecting from various sets of data available, adjusting image quality, etc.

Interface 24 is coupled to a vehicle interior element in this exemplary embodiment, and is configured to establish a communication link 26 with portable computing device 115 via an interface 113 associated with portable computing device 115. As mentioned, communication link 26 can include any of a number of data formats and may be a wired or wireless connection. Communication link 26 is illustrated as a wireless connection in this exemplary embodiment, which can be an infrared or radio frequency communication link. Alternatively, interface 113 and interface 24 can include pin connector-type plugs, jacks, or sockets configured to receive a multi-wire communication bus for wired communication between processing circuit 20 and portable computing device 115.

In operation, a user can load data, such as navigation data, onto portable computing device 115 (as will be described hereinbelow). The user can then bring portable computing device 115 to the user's vehicle 10 and transmit or communicate the data via communication link 26 to system 12 in the vehicle 10. The user can then display the data in the vehicle 10 for use as the vehicle travels. In one example, a user must bring portable computing device 115 within approximately 10 meters of system 12 in order to communicate via a Bluetooth communication standard. In another example, one or both of system 12 and portable computing device 115 can be continuously monitoring for the presence of one another within a predetermined range (e.g., 10 meters) and upon detecting the presence of one another, system 12 and device 115 can automatically establish communication link 26 and begin the transfer of data.

According to one advantageous aspect of this exemplary embodiment, system 12 does not receive data from a location determination circuit, such as, a global positioning system (GPS) receiver. System 12 avoids the cost and additional equipment required for a GPS system.

According to another advantageous aspect of this embodiment, system 12 does not receive data from a navigation database, such as a geographic information system (GIS) database of roads, way points, etc. System 12 avoids the cost, physical space requirements, and needs for updates of information associated with a GIS database.

System 12 does not show the current location of the vehicle on display unit 22 as the vehicle travels in this exemplary embodiment. Accordingly, a location determination circuit and a geographic information database are not required for the system of this embodiment. System 12 can still, however, display navigation data, such as maps, turn-by-turn or step-by-step directional data, and other data on display unit 22 for the use of the vehicle occupants. In this embodiment, system 12 is a low-cost and less complex alternative to conventional autonomous navigation display systems that require a location determination circuit and a navigation database.

According to one alternative embodiment, display unit 22 can be replaced with a speaker or other audio output, and the data received from portable computing device 115 can be audio data that is played via the speaker. In another embodiment, both audible and visible data can be displayed via system 12.

In this embodiment, system 12 is a fixed computing device coupled to a vehicle interior element.

According to one alternative embodiment, processing circuit 20 can include a small amount of memory (e.g., 10-30 megabytes) for storing temporarily or permanently a small amount of data from portable computing device 115. The memory may be a non-volatile or volatile memory and can be configured of a size to hold several screens of data for displaying unit 22.

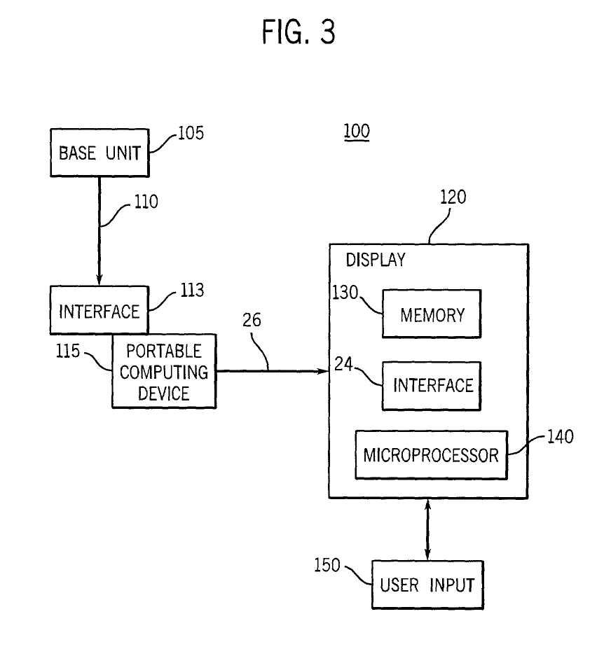

FIG. 3 is a functional block diagram illustrating a system 100 according to another embodiment of the present invention. System 100 includes a base unit 105, portable computing device 115, interface 113, a connection or communication link 110 there-between, and a display unit 120. Display unit 120 includes a memory unit 130 and a microprocessor 140. User input mechanism 150 is coupled to display unit 120.

Base unit 105 may be a desktop computer, a laptop computer or any other type of computer or data source. Base unit 105 may also include a transmitter on a billboard, at a gas station, or at a kiosk (e.g., an information center) configured to transmit any type of information to portable computing device 115. Base unit 105 may be located at rest stops along the highway or at various kiosks throughout shopping malls.

Base unit 105 transmits information via connection 110 to interface 113 of portable computing device 115. Connection 110 may be hardwired, wireless, electronic, RF, infrared, etc. Interface 113 is an electrical and/or mechanical interface configured to receive the data from base unit 105 via connection 110 and to provide the data to portable computing device 115. Portable computing device 115 may be a personal digital assistant (PDA), such as a Palm Pilot® brand PDA or Blackberry® brand PDA. Portable computing device 115 may also be a cellular telephone, a pager, a laptop computer, a desktop computer, etc.

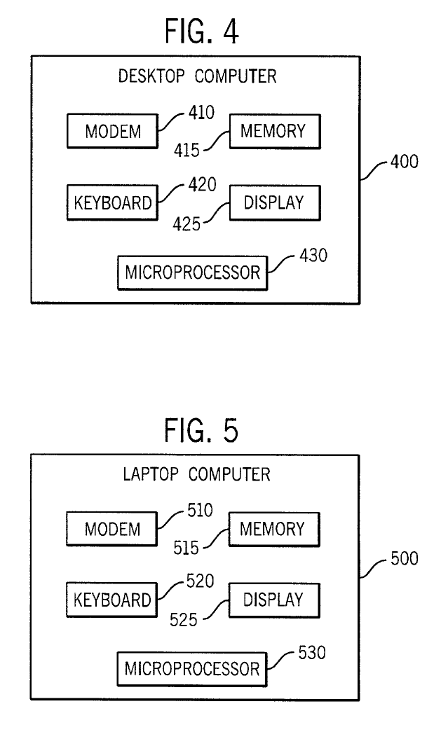

Referring to FIG. 4, desktop computer 400 is illustrated as one example of portable computing device 115. Desktop computer 400 includes a communications interface circuit (e.g., modem, Internet link, etc.) 410, a memory 415, a keyboard 420, a display 425 and a microprocessor 430. Communications interface 410 may be adapted to be coupled to a telephone line. The telephone line is coupled to a public switched telephone network (PSTN). Communications interface 410 may be a serial modem, a stand-alone modem, a PCMCIA modem, a modem for use with a specialty wireless transmission network, or it may be a type custom designed for the desktop computer 400. Microprocessor 430 responds to program instructions and data stored in memory 415. Keyboard 420 is an input source and display 425 is an output source to display the information.

Referring to FIG. 5, a laptop computer 500 is illustrated as another example of a portable computing device 115. Laptop computer 500 includes a modem 510, a memory 515, a keyboard 520, a display 525 and a microprocessor 530. Modem 510 is coupled to an antenna for sending and receiving cellular telephone calls in conjunction with a cellular telephone network. Modem 510 may be, for example, any of the modem types described in conjunction with communications interface 410 of desktop computer 400. Microprocessor 530 responds to program instructions and data stored in memory 515. Keyboard 520 and display 525 have the same functions as keyboard 420 and display 425 of desktop computer 400 in FIG. 4.

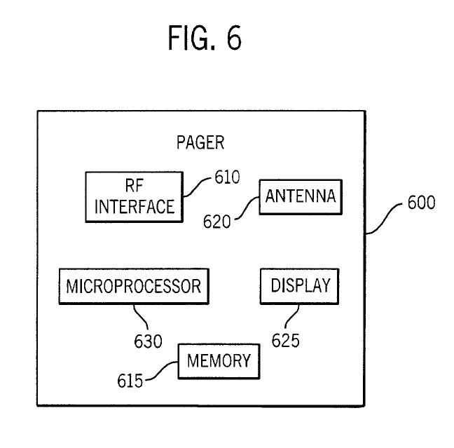

Referring to FIG. 6, a pager 600 is illustrated as another example of a portable computing device 115. Pager 600 includes a radio frequency (RF) interface 610 coupled to an antenna 620 for receiving RF signals from an antenna coupled to base unit 105 (FIG. 3). Pager 600 further includes a microprocessor 630 responsive to program instructions and data stored in a memory 615. In response to information transmitted from base unit 105 and received at antenna 620, microprocessor 630 displays information, such as directional information, on a display 625.

Referring again to FIG. 3, portable computing device 115 transmits the received information from base unit 105 to display unit 120 via communication link 26. The information is received by interface 24, provided to memory unit 130 and then displayed on display unit 120 under control of microprocessor 140 in this exemplary embodiment. Display unit 120 does not continuously monitor the location of the vehicle using a location determination circuit. Thus, this embodiment eliminates the need for costly additional antennas, receivers, and databases. The user may control display unit 120 by using user input mechanism 150. The user input mechanism 150 may be a remote control, a keyboard, a mouse, a scroll device, buttons, a joystick, a switch, a voice recognition module, a touch screen interface, etc.

According to one exemplary use of the embodiment of FIG. 3, a user must travel to a specific address in the user's car and does not know the way to reach the specific address. The user accesses the Internet on a desktop computer 400 and searches the Internet to find directions from an original point to a destination point. Once the directions are displayed on desktop computer 400, the user downloads the directional information onto portable computing device 115, such as a PDA. This downloading can occur through a hardwired connection between the desktop computer and the PDA 115 or may also be done through a wireless connection.

In the user's vehicle 10, a display unit 120 has a screen enabling the driver to view the screen while driving. Display unit 120 has an interface 24 to receive information from portable computing device 115. The user transmits the directional information from portable computing device 115 to display unit 120 in vehicle 10. The directional information is stored and processed. A map of the area, along with step-by-step directions are displayed on display unit 120.

Using user input mechanism 150, the user alters the map and step-by-step directions according to personal preferences. Display unit 120 also includes an audio device. If the user selects an audio option, the directions are read out to the driver over a microphone speaker device installed in the automobile.

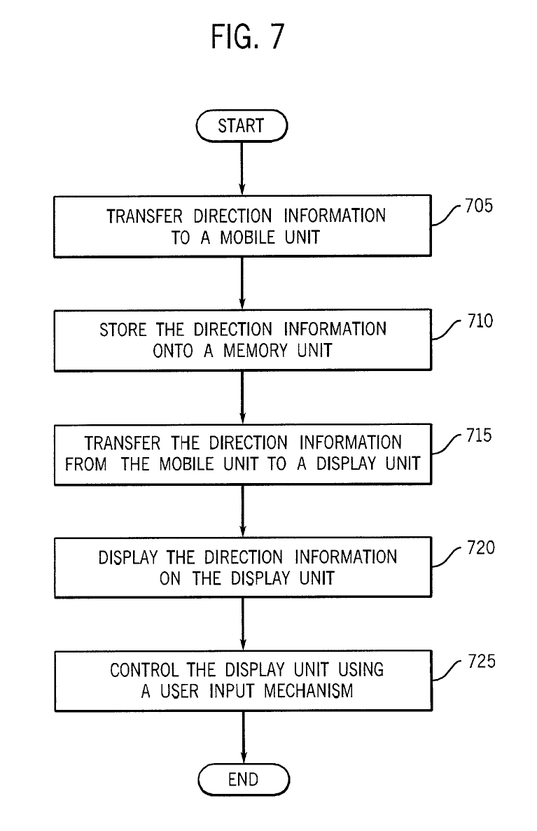

FIG. 7 is a flow diagram illustrating a method according to an exemplary embodiment of the present invention. At step 705, base unit 105 transfers direction or navigation information (e.g., a map, turn-by-turn directions, etc.) to portable computing device 115. Base unit 105 may be a desktop computer, a laptop computer, a kiosk, etc. Direction information is stored, in step 710, to a memory unit within portable computing device 115. At step 715, direction information is transferred from portable computing device 115 to display unit 120. Display unit 120 is coupled to the interior operator's station of a vehicle 10, such as an automobile, train, plane, boat or agricultural vehicle. Transferring may occur through a hardwired, wireless, RF, or electronic connection. At step 720, direction information is displayed on display unit 120. The user controls display unit 120 using a user input mechanism 150, in step 725.

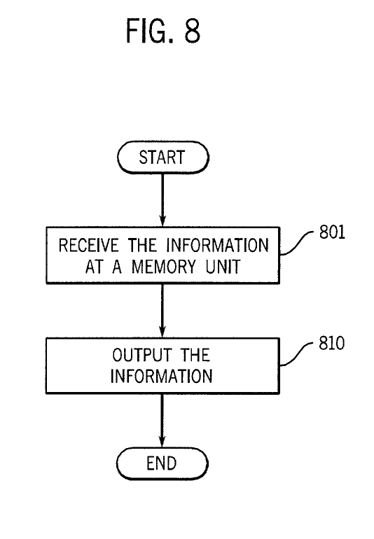

FIG. 8 illustrates a flow diagram according to another exemplary embodiment of the present invention. At step 801, information is received at a memory unit 130 from a base unit 105. Base unit 105 may be a desktop computer 400, a laptop computer 500, a kiosk, a billboard, a transmitter at a gas station, etc. Information being transmitted may comprise various types of information, such as direction or navigation data, information about the weather, tourist attractions, prices of gas, promotional items, etc. At step 810, the information can be output on display unit 120 or, through a speaker unit.

Other exemplary embodiments are apparent to those skilled in the art from a consideration of the specification and the practice of the invention disclosed therein. It is intended that the specification be considered as exemplary only with the true scope of the invention being indicated by the following claims.

What is claimed is:

1. A system for displaying information to a user in a vehicle having a vehicle interior element, the system comprising:
an interface coupled to the vehicle interior element configured to establish a communication link with a portable computing device;
a display unit; and
a processing circuit configured to receive the information from the portable computing device and to provide the information for display on the display unit.

2. The system according to claim 1, further comprising a user input mechanism configured to control the display unit, wherein the processing circuit adjusts the display of the information in response to user activation of the user input mechanism.

3. The system according to claim 1, wherein the system does not receive data from a global positioning system.

4. The system according to claim 1, wherein the system does not receive data from a navigation database.

5. The system according to claim 2, wherein the user input mechanism comprises a button.

6. The system according to claim 1, wherein the processing circuit and display unit are configured to display map data received from the portable computing device.

7. The system according to claim 1, wherein the communications link is a wireless communications link.

8. The system according to claim 1, wherein the interface is configured to be coupled to a personal digital assistant.

9. The system according to claim 1, wherein the vehicle interior element is an instrument panel, an overhead console, a visor, a steering wheel, or a windshield of an automotive vehicle.

10. A method for displaying navigation information to a user in a vehicle, the method comprising the steps of:
receiving the navigation information from a portable computing device via a communication link; and
displaying the navigation information on a display unit coupled to a vehicle interior element, wherein the current location of the vehicle is not displayed on the display unit.

11. The method according to claim 10, further comprising receiving a user input from a vehicle occupant and controlling the display of navigation information based on the user input.

12. The method according to claim 10, wherein the portable computing device is a personal digital assistant.

13. The method according to claim 10, further comprising storing the navigation data in a memory.

14. The method according to claim 10, wherein the vehicle interior element is an instrument panel, an overhead console, a visor, a steering wheel, or a windshield of an automotive vehicle.

15. A method for providing navigation data to a vehicle occupant in a vehicle, the method comprising the steps of:
receiving the navigation data from a portable computing device at a fixed computing device coupled to a vehicle interior element; and
providing the navigation data to the vehicle occupant via an output device.

16. The method according to claim 15, wherein the navigation data is audio data and the output device is a speaker.

17. The method according to claim 15, wherein the navigation data includes step-by-step directional data.

18. The method according to claim 15, wherein the portable computing device is a personal digital assistant.

19. The method according to claim 15, wherein the navigation data is provided to the output device without receiving vehicle location data.

20. The method according to claim 15, further comprising establishing a wireless communication link between the portable computing device and the fixed computing device.

21. The method according to claim 15, wherein the vehicle interior element is an instrument panel, an overhead console, a visor, a steering wheel or a windshield of an automotive vehicle.

22. An apparatus for displaying navigation data to a vehicle occupant in a vehicle, the apparatus comprising:
means for receiving the navigation data from a portable computing device at a fixed computing device coupled to a vehicle interior element; and
means for providing the navigation data to the vehicle occupant via an output device.

23. An apparatus according to claim 22, wherein the navigation data is audio data and the output device is a speaker.

24. The apparatus according to claim 22, wherein the portable computing device is a personal digital assistant.

25. The apparatus according to claim 22, wherein the navigation data is provided to the output device without receiving vehicle location data.

26. The apparatus according to claim 22, wherein the vehicle interior element is an instrument panel, an overhead console, or a visor of an automotive vehicle.
